(19) United States
(12) Patent Application Publication
(10) Pub. No.: US 2024/0242556 A1
(43) Pub. Date: Jul. 18, 2024

(54) MONEY STORAGE DEVICE

(71) Applicant: TOSHIBA TEC KABUSHIKI KAISHA, Tokyo (JP)

(72) Inventor: Masaki Ito, Numazu Shizuoka (JP)

(21) Appl. No.: 18/482,033

(22) Filed: Oct. 6, 2023

(30) Foreign Application Priority Data
Jan. 13, 2023 (JP) 2023-003517

(51) Int. Cl. G07D 1/06; G07D 3/16; G07D 5/00; G07D 11/237; G07D 11/60

(52) U.S. Cl. CPC G07D 1/06; G07D 3/16; G07D 5/00; G07D 11/237; G07D 11/60; G07D 11/34

(57) ABSTRACT

A coin change machine includes a reception counting unit to count types and the numbers of received coins, a storage state calculating unit to accumulate a counting result of the reception counting unit to thereby calculate types and the numbers of stored coins, a dispensing counting unit to count types and the numbers of dispensed or collected coins and an illumination control unit to turn on LEDs, which illuminate the inside of a storing unit, on condition that a lid covering the storing unit for coins is opened, if the types and the numbers of the coins calculated by the storage state calculating unit and the types and the numbers of the coins counted by the dispensing counting unit if the coins are collected or instructed dispensing content and the types and the number of the coins counted by the dispensing counting unit, are inconsistent.

### CROSS-REFERENCE TO RELATED APPLICATION

This application is based upon and claims the benefit of priority from Japanese Patent Application No. 2023-003517, filed on Jan. 13, 2023, the entire contents of which are incorporated herein by reference.

### FIELD

Embodiments described herein relate generally to a money storage device, a money handling method, and a coin change machine.

### BACKGROUND

There has been known a coin storage device that identifies right or wrong of coins taken in from the outside and stores coins identified as normal while dividing the coins by denominations.

In such a coin storage device, if a coin jam occurs, it is necessary to open a lid of the coin storage device and remove the coin jam. However, since the inside of a storing unit is dark, it is hard to check a state of the jam and workability is poor. On the other hand, there has been disclosed a technique for installing an imaging unit such as a camera on the inside of a coin storage device and imaging and monitoring a state of the inside of the coin storage device. For example, an LED light is installed on the inside of the coin storage device in order to capture a clear image. However, since the imaging unit needs to be installed, the structure of the device is complicated, causing an increase in cost.

### BRIEF DESCRIPTION OF THE DRAWINGS

FIG. 1 is a perspective view illustrating an exterior of a coin change machine in an embodiment;

FIG. 2 is an XY sectional view schematically illustrating internal structure of the coin change machine;

FIG. 3 is a YZ sectional view schematically illustrating the internal structure of the coin change machine;

FIG. 4 is a hardware block diagram illustrating an example of a hardware configuration of the coin change machine;

FIG. 5 is a functional block diagram illustrating an example of a functional configuration of the coin change machine; and

FIG. 6 is a flowchart illustrating an example of a flow of illumination turning-on processing performed by the coin change machine.

### DETAILED DESCRIPTION

An aspect of embodiments is to provide a money storage device that can support, if a coin jam occurs, work for eliminating the jam without a significant increase in cost.

A money storage device in an embodiment includes a reception counting unit, a calculating unit, a dispensing counting unit, and an illumination control unit. The reception counting unit counts a type and a number of pieces of money received from an outside. The calculating unit accumulates a counting result of the reception counting unit to thereby calculate a type and a number of pieces of stored money. The dispensing counting unit counts a type and a number of pieces of dispensed or collected money. The illumination control unit causes an illumination device, which illuminates an inside of a storing unit, on condition that a lid covering the storing unit for money is opened, if the type and the number of pieces of the money calculated by the calculating unit and the type and the number of pieces of the money counted by the dispensing counting unit if the money is collected are inconsistent or if instructed dispensing content and the type and the number of pieces of the money counted by the dispensing counting unit are inconsistent.

A coin change machine 10 to which the present disclosure is applied is explained with reference to the drawings.

### (Schematic Configuration of the Coin Change Machine)

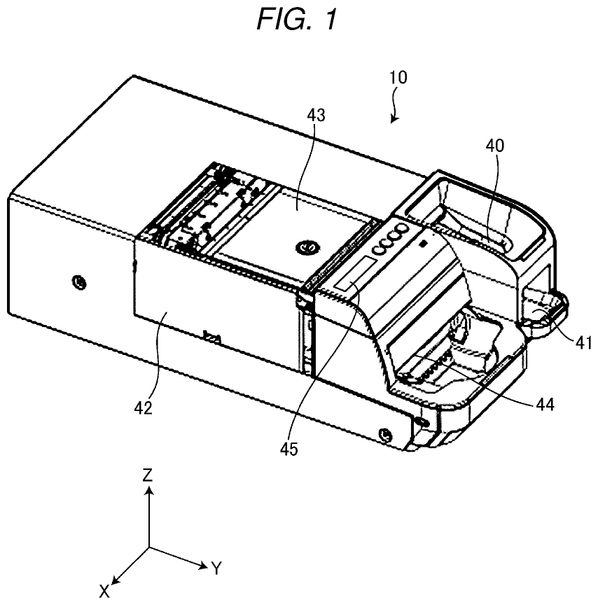

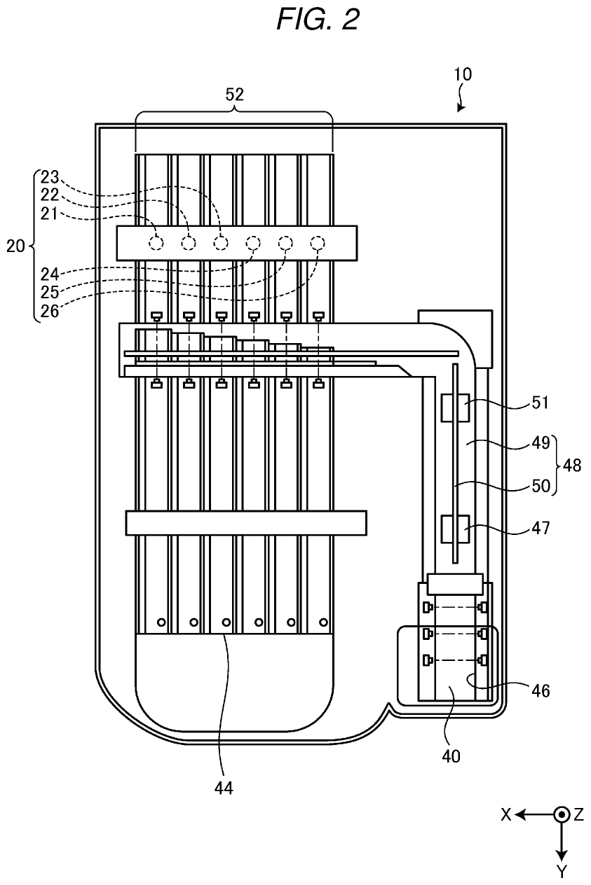

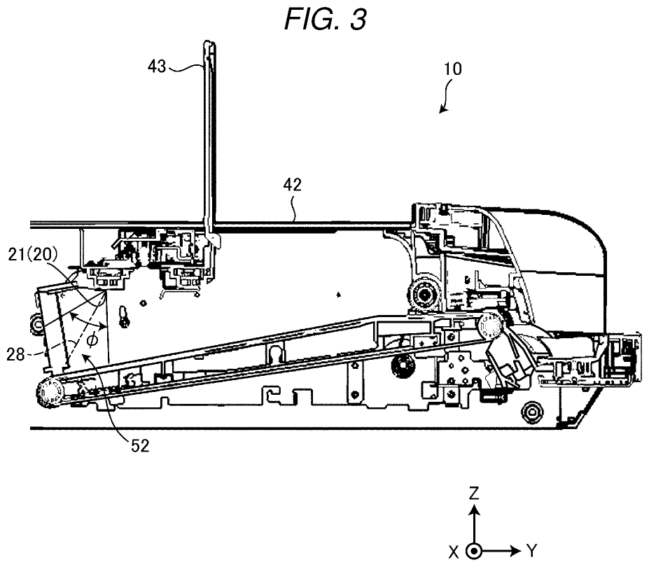

Schematic structure of the coin change machine 10 is explained with reference to FIGS. 1, 2, and 3. FIG. 1 is an exterior view illustrating an example of a coin change machine in the embodiment. FIG. 2 is an XY sectional view schematically illustrating internal structure of the coin change machine in the embodiment. FIG. 3 is a YZ sectional view schematically illustrating the internal structure of the coin change machine in the embodiment.

As illustrated in FIG. 1, the coin change machine 10 includes a depositing port 40, a reject tray 41, a storage 42, a lid 43, a dispensing port 44, and a display device 45. Note that the coin change machine 10 is an example of the money storage device in the present disclosure.

The depositing port 40 includes an opening 46 (see FIG. 2) opened to the outside and receives coins from the opening 46 and takes the coins into the inside of the coin change machine 10. The coins taken into the inside are identified by an identifying unit 47 (see FIG. 2) explained below. Coins determined as normal are stored in the storage 42 for each of denominations. Note that coins determined as not normal by the identifying unit 47 is discharged to the reject tray 41.

The lid 43 capable of opening and closing is installed above the storage 42. An operator can open the lid 43 and visually check the inside of the storage 42.

The display device 45 displays information relating to an operation of the coin change machine 10. The information relating to the operation of the coin change machine 10 is, for example, information indicating that a deficiency such as a coin jam occurred, information indicating that change is absent, information indicating a total amount of deposited coins, and information indicating a dispensing amount of change. Note that the display device 45 is, for example, a liquid crystal panel or an organic EL panel.

The coin change machine 10 calculates a dispensing amount serving as change for a deposit amount deposited from the depositing port 40. The coin change machine 10 dispenses coins corresponding to the calculated dispensing amount from the dispensing port 44.

Further, the coin change machine 10 includes an identifying unit 47, a conveying unit 48, a reject unit 51, a storing unit 52, and LEDs 20 illustrated in FIG. 2.

The identifying unit 47 identifies right or wrong of coins deposited from the depositing port 40. An identification method by the identifying unit 47 may be any method. However, whether coins are correct is identified by, for example, an optical method or a mechanical method.

The conveying unit 48 conveys coins from the depositing port 40 to the storing unit 52 through the identifying unit 47. The conveying unit 48 includes a conveyance surface 49 and a conveying belt 50. The conveyance surface 49 is a plane formed of a metal plate and supports coins from the lower surfaces of the coins. The conveying belt 50 is an endless belt and is disposed on the conveyance surface 49 while being stretched at predetermined tension by a pair of pulleys (not illustrated) and is rotated by one of the pulleys being driven. The conveying belt 50 rotates in contact with the upper surfaces of the coins on the conveyance surface 49 to thereby slide the coins along the conveyance surface 49 and convey the coins to the storing unit 52.

The reject unit 51 includes a hole (not illustrated) formed on the conveyance surface 49 and an opening and closing section (not illustrated) for opening and closing the hole. The reject unit 51 causes the opening and closing section to open and close the hole based on an output of the identifying unit 47 to thereby drop abnormal coins from the hole and discharges the abnormal coins to the reject tray 41.

The storing unit 52 stores coins identified as normal by the identifying unit 47 (normal coins, species) in lanes determined for each of denominations. Specifically, the storing unit 52 includes six lanes for storing coins and stores 1-yen coins, 5-yen coins, 10-yen coins, 50-yen coins, 100-yen coins, and 500-yen coins in the lanes to be arrayed in the thickness direction.

The LEDs 20 are installed for each of the lanes configuring the storing unit 52 and illuminate the inside (a Y-axis negative side in FIG. 2) of the storing unit 52. That is, six LEDs 20 are installed. For example, an LED 21 illuminates the inside of the lane in which the 1-yen coins are stored. An LED 22 illuminates the inside of the lane in which the 5-yen coins are stored. An LED 23 illuminates the inside of the lane in which the 10-yen coins are stored. An LED 24 illuminates the inside of the lane in which the 50-yen coins are stored. An LED 25 illuminates the inside of the lane in which the 100-yen coins are stored. An LED 26 illuminates the inside of the lane in which the 500-yen coins are stored. Note that the coin change machine 10 has to turn on the LEDs 20 only if the lid 43 is opened.

All the LEDs 20 have irradiation angles ϕ as illustrated in FIG. 3. All of center lines of the irradiation angles θ, that is, optical axes 28 of the LEDs 20 are set to face the inside (the Y-axis negative side) of the storing unit 52. Consequently, the inner side of the storing unit 52 is brightly illuminated. Note that the LEDs 20 are turned on by a direct current. A light emission wavelength of the LEDs 20 may be any light emission wavelength. However, in order to improve visibility, it is desirable to use, rather than light having a specific wavelength, white light including lights in many wavelength regions. The LEDs 20 are an example of the illumination devices in the present disclosure.

If the operator peeks into the inside of the storing unit 52 in the storage 42 from the opened lid 43, the operator can easily visually check a state of coins on the inside of the storing unit 52 illuminated by the LEDs 20. The operator can insert a finger into the inside of the storing unit 52 and easily eliminate a coin jam.

Note that, as explained below, the coin change machine 10 can specify a type of a coin that caused a jam. Therefore, if the lid 43 is opened, the coin change machine 10 desirably turns on only the LED 20 installed in the lane where the jam occurs, that is, the LED 20 corresponding to a coin type that caused the jam among the LEDs 21, 22, 23, 24, 25, and 26. Naturally, if the lid 43 is opened, the coin change machine 10 may turn on all of the LEDs 20.

Note that the turned-on LED 20 is turned off if the lid 43 is closed.

### (Hardware Configuration of the Coin Change Machine)

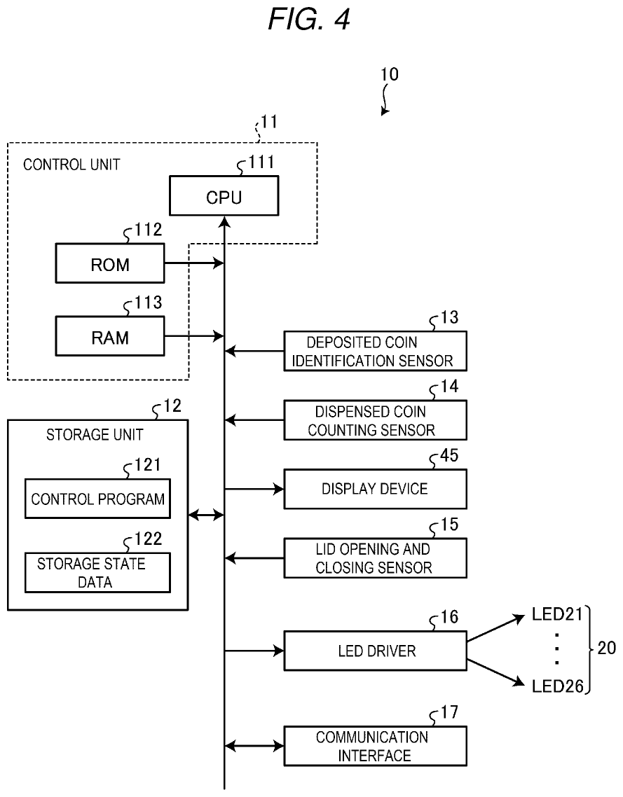

A hardware configuration of the coin change machine 10 is explained with reference to FIG. 4. FIG. 4 is a hardware block diagram illustrating an example of a hardware configuration of the coin change machine in the embodiment.

As illustrated in FIG. 4, the coin change machine 10 includes a control unit 11. The control unit 11 includes a CPU (Central Processing Unit) 111 that executes various kinds of processing relating to the coin change machine 10 and a ROM (Read Only Memory) 112 and a RAM (Random Access Memory) 113, which are storage media. The ROM 112 stores various programs to be executed by the CPU 111, various data, and the like. If the CPU 111 executes the various programs, the RAM 113 temporarily stores data and the programs. That is, the control unit 11 has a configuration of a general computer.

The control unit 11 is connected to a storage unit 12 and various kinds of peripheral equipment.

The storage unit 12 is a storage device such as a HDD (Hard Disk Drive) or an SSD (Solid State Drive). The storage unit 12 may be a nonvolatile memory such as a flash memory in which stored information is retained even if power is turned off. The storage unit 12 stores a control program 121 and storage state data 122.

The control program 121 is a program for controlling an operation of the entire coin change machine 10.

Note that the control program 121 to be executed by the coin change machine 10 in this embodiment may be provided by being recorded in a computer-readable recording medium such as a CD-ROM. The control program 121 may be provided by being stored on a computer connected to a network such as the Internet and downloaded through the network. Further, the control program 121 may be provided or distributed through a network such as the Internet.

The storage state data 122 is a data file indicating types and the numbers of coins stored in the storing unit 52 of the coin change machine 10 at that point in time. Every time new depositing or dispensing is performed, the coin change machine 10 counts types and the numbers of deposited or dispensed coins to update the storage state data 122.

The control unit 11 is connected to various kinds of peripheral equipment necessary for causing the coin change machine 10 exert required functions. Specifically, the control unit 11 is connected to a deposited coin identification sensor 13, a dispensed coin counting sensor 14, a lid opening and closing sensor 15, an LED driver 16, a communication interface 17, and a display device 45 via an internal bus.

The deposited coin identification sensor 13 identifies whether coins received from the outside are correct coins. The deposited coin identification sensor 13 counts types and the numbers of the coins received from the outside.

The dispensed coin counting sensor 14 counts types and the numbers of dispensed or collected coins.

The lid opening and closing sensor 15 detects an opening and closing state of the lid 43.

The LED driver 16 turns on or turns off the LEDs 21, 22, 23, 24, 25, and 26 independently from one another.

The communication interface 17 connects the coin change machine 10 and a checkout machine such as a POS terminal. The coin change machine 10 communicates information relating to a deposit amount, a dispensed amount, a change amount, and the like with the checkout machine via the communication interface 17.

The display device 45 displays various kinds of information relating to an operation state of the coin change machine 10.

### (Functional Configuration of the Coin Change Machine)

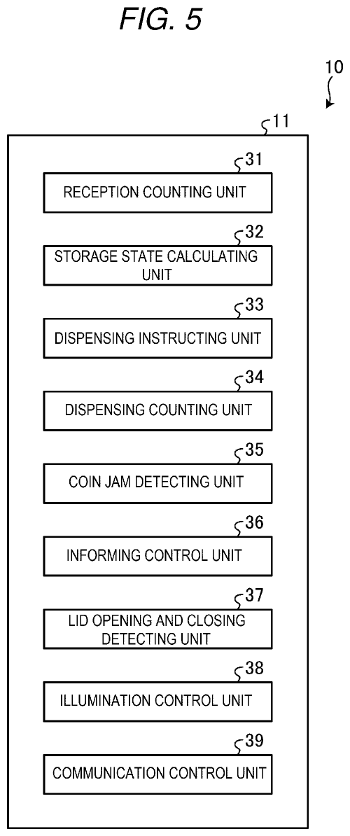

A functional configuration of the coin change machine 10 is explained with reference to FIG. 5. FIG. 5 is a functional block diagram illustrating an example of a functional configuration of the coin change machine in the embodiment.

The control unit 11 of the coin change machine 10 loads the control program 121 in the RAM 113 and causes the control program 121 to operate to thereby implement, as functional units, a reception counting unit 31, a storage state calculating unit 32, a dispensing instructing unit 33, a dispensing counting unit 34, a coin jam detecting unit 35, an informing control unit 36, a lid opening and closing detecting unit 37, an illumination control unit 38, and a communication control unit 39 illustrated in FIG. 5. Note that a part or all of these functions may be implemented by dedicated hardware.

The reception counting unit 31 counts types and the numbers of coins received from the outside. The reception counting unit 31 identifies whether the received coins are normal coins. If the received coins are not the normal coins, the reception counting unit 31 discharges the coins to the reject tray 41.

The storage state calculating unit 32 accumulates a counting result of the reception counting unit 31 to thereby calculate types and the numbers of coins stored by the storing unit 52. The storage state calculating unit 32 is an example of the calculating unit in the present disclosure.

The dispensing instructing unit 33 compares the counting result of the reception counting unit 31 and a necessary deposit amount to thereby calculate a change amount and instructs the dispensing counting unit 34 to dispense the change amount. The dispensing instructing unit 33 instructs, based on an operation instruction of the coin change machine 10, the dispensing counting unit 34 to collect the coins stored in the storing unit 52.

If receiving the dispensing instruction or the collection instruction, the dispensing counting unit 34 dispense or collect the coins. The dispensing counting unit 34 counts types and the numbers of the dispensed or collected coins.

The coin jam detecting unit 35 determines whether the types and the numbers of the coins calculated by the storage state calculating unit 32 and the types and the numbers of the coins counted by the dispensing counting unit 34 if the coins are collected are inconsistent. If the types and the numbers of the coins are inconsistent, the coin jam detecting unit 35 determines that a coin jam occurred. The coin jam detecting unit 35 determines whether dispensing content instructed by the dispensing instructing unit 33 and the types and the numbers of the coins counted by the dispensing counting unit 34 are inconsistent. If the dispensing content and the types and the numbers of the coins are inconsistent, the coin jam detecting unit 35 determines that a coin jam occurred.

If the coin jam detecting unit 35 detects occurrence of a coin jam, the informing control unit 36 presents, to the display device 45, information indicating that the coin jam occurred. Note that the informing control unit 36 may blow a buzzer not illustrated in FIG. 4 to thereby inform that the coin jam occurred.

The lid opening and closing detecting unit 37 detects an opening and closing state of the lid 43.

If the types and the numbers of the coins calculated by the storage state calculating unit 32 and the types and the numbers of the coins counted by the dispensing counting unit 34 if the coins are collected are inconsistent or the dispensing content instructed by the dispensing instructing unit 33 and the types and the numbers of the coins counted by the dispensing counting unit 34 are inconsistent, on condition that the lid 43 covering the storing unit 52 for coins is opened, the illumination control unit 38 turns on the LEDs 20 (the illumination devices) that illuminate the inside of the storing unit 52. The illumination control unit 38 turns on the LED 20 corresponding to a type of a coin that caused the inconsistency. The illumination control unit 38 turns off the LED 20 if the lid 43 is closed. If the types and the numbers of the coins calculated by the storage state calculating unit 32 and the types and the numbers of the coins counted by the dispensing counting unit 34 if the coins are collected are consistent and the instructed dispensing content and the types and the numbers of the coins counted by the dispensing counting unit 34 are consistent, the illumination control unit 38 turns on all of the LEDs 20 on condition that the lid 43 covering the storing unit 52 for the coins is opened.

The communication control unit 39 communicates information relating to a deposit amount, an dispensing amount, a change amount, and the like between the coin change machine 10 and a not-illustrated checkout machine.

### (Flow of Illumination Turning-on Processing Performed by the Coin Change Machine)

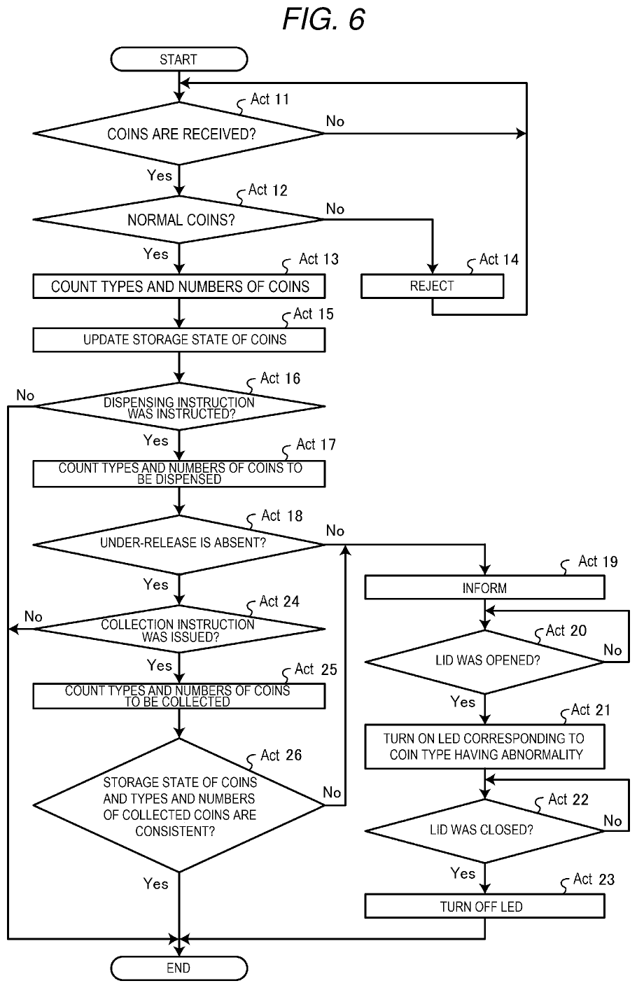

A flow of illumination turning-on processing performed by the coin change machine 10 is explained. FIG. 6 is a flowchart illustrating an example of a flow of illumination turning-on processing performed by the coin change machine in the embodiment.

The reception counting unit 31 determines whether coins were received from the outside, that is, whether coins were deposited (Act 11). If the reception counting unit 31 determines that coins were received from the outside (Yes in Act 11), the processing proceeds to Act 12. On the other hand, if not determining that coins were received from the outside (No in Act 11), the reception counting unit 31 repeats Act 11.

If determining in Act 11 that coins were received from the outside, the reception counting unit 31 determines whether the received coins are normal coins (Act 12). If the reception counting unit 31 determines that the received coins are the normal coins (Yes in Act 12), the processing proceeds to Act 13. On the other hand, if the reception counting unit 31 does not determine that the received coins are the normal coins (No in Act 12), the processing proceeds to Act 14.

If determining in Act 12 that the received coins are the normal coins, the reception counting unit 31 counts types and the numbers of the received coins (Act 13). Thereafter, the processing proceeds to Act 15.

On the other hand, if not determining in Act 12 that the received coins are the normal coins, the reception counting unit 31 discharges the coins to the reject tray 41 (Act 14). Thereafter, the processing returns to Act 11.

Following Act 13, the storage state calculating unit 32 updates the storage state data 122 indicating a storage state of coins (Act 15).

The dispensing counting unit 34 determines whether a coin dispensing instruction was issued from the dispensing instructing unit 33 (Act 16). If the dispensing counting unit 34 determines that the coin dispensing instruction was issued (Yes in Act 16), the processing proceeds to Act 17. On the other hand, if the dispensing counting unit 34 does not determine that the coin dispensing instruction was issued (No in Act 16), the coin change machine 10 ends the processing illustrated in FIG. 6.

If determining in Act 16 that the coin dispensing instruction was issued, the dispensing counting unit 34 counts types and the numbers of coins to be dispensed (Act 17).

The coin jam detecting unit 35 determines whether a so-called under-release, in which an actually dispensed amount is less than an amount instructed to be dispensed, is absent (Act 18). If the coin jam detecting unit 35 determines that the under-release is absent (Yes in Act 18), the processing proceeds to Act 24. On the other hand, if the coin jam detecting unit 35 does not determine that the under-release is absent (No in Act 18), that is, if the coin jam detecting unit 35 determines that the under-release is present, the processing proceeds to Act 19.

If the coin jam detecting unit 35 determines in Act 18 that the under-release is present, the informing control unit 36 displays, on the display device 45, information indicating that the coin jam occurred (Act 19).

The lid opening and closing detecting unit 37 determines whether the lid 43 was opened (Act 20). If the lid opening and closing detecting unit 37 determines that the lid 43 was opened (Yes in Act 20), the processing proceeds to Act 21. On the other hand, if not determining that the lid 43 was opened (No in Act 20), the lid opening and closing detecting unit 37 repeats Act 20.

If the lid opening and closing detecting unit 37 determines in Act 20 that the lid 43 was opened, the illumination control unit 38 turns on the LED 20 corresponding to coins having a deficiency in the number (Act 21).

The lid opening and closing detecting unit 37 determines whether the lid 43 was closed (Act 22). If the lid opening and closing detecting unit 37 determines that the lid 43 was closed (Yes in Act 22), the processing proceeds to Act 23. If not determining that the lid 43 was closed (No in Act 22), the lid opening and closing detecting unit 37 repeats Act 22.

If the lid opening and closing detecting unit 37 determines in Act 22 that the lid 43 was closed, the illumination control unit 38 turns of the lighting LED 20 (Act 23). Thereafter, the coin change machine 10 ends the processing illustrated in FIG. 6.

The processing returns to Act 18. If the coin jam detecting unit 35 determines in Act 18 that the under-release is absent, the dispensing counting unit 34 determines whether a coin collection instruction was issued from the dispensing instructing unit 33 (Act 24). If the dispensing counting unit 34 determines that the coin collection instruction was issued (Yes in Act 24), the processing proceeds to Act 25. On the other hand, if the dispensing counting unit 34 does not determine that the coin collection instruction was issued (No in Act 24), the coin change machine 10 ends the processing illustrated in FIG. 6.

If determining in Act 24 that the coin collection instruction was issued, the dispensing counting unit 34 counts types and the numbers of coins to be collected (Act 25).

The coin jam detecting unit 35 determines whether a storage state of the coins in the storing unit 52 and the types and the numbers of the coins to be collected counted by the dispensing counting unit 34 are consistent (Act 26). If the coin jam detecting unit 35 determines that the storage state of the coins and the types and the numbers of the coins to be collected are consistent (Yes in Act 26), the coin change machine 10 ends the processing illustrated in FIG. 6. On the other hand, if the coin jam detecting unit 35 does not determine that the storage state of the coins and the types and the numbers of the coins to be collected are consistent (Yes in Act 26), the processing proceeds to Act 19. Thereafter, the coin change machine 10 performs the processing explained above.

Note that, if maintenance of the coin change machine 10 is performed, in order to improve visibility of the inside of the storing unit 52, the illumination control unit 38 may turn on all of the LEDs 20 (21, 22, 23, 24, 25, and 26) if the lid 43 is opened in a state in which a coin jam occurred.

The coin change machine 10 is explained as an example above. However, the present disclosure can also be applied to a money storage device that stores both of bills and coins.

### (Action Effects of the Embodiment)

As explained above, the coin change machine 10 (the money storage device) in this embodiment includes the reception counting unit 31 that counts types and the numbers of coins received from the outside, the storage state calculating unit 32 (the calculating unit) that accumulates a counting result of the reception counting unit 31 to thereby calculate types and the numbers of stored coins, the dispensing counting unit 34 that counts types and the numbers of dispensed or collected coins, and the illumination control unit 38 that turns on the LEDs 20 (the illumination devices), which illuminate the inside of the storing unit 52, on condition that the lid 43 covering the storing unit 52 for coins is opened, if the types and the numbers of the coins calculated by the storage state calculating unit 32 and the types and the numbers of the coins counted by the dispensing counting unit 34 if the coins are collected are inconsistent or the instructed dispensing content and the types and the numbers of the coins counted by the dispensing counting unit 34 are inconsistent. Therefore, if a coin jam occurs, it is possible to support work for eliminating the coin jam without a significant increase in cost only by installing the LEDs 20.

In the coin change machine 10 (the money storage device) in this embodiment, the LEDs 20 (the illumination devices) are installed for each of types of coins stored in the storing unit 52. The illumination control unit 38 turns on the LED 20 corresponding to a type of a coin that caused inconsistency. Therefore, since only a lane corresponding to a type of a coin that caused a jam is illuminated, it is possible to save power consumption of the LEDs 20.

In the coin change machine 10 (the money storage device) in this embodiment, the illumination control unit 38 turns off the LED 20 (the illumination device) if the lid 43 is closed. Therefore, it is possible to turn off the LED 20 without performing special operation.

In the coin change machine 10 (the money storage device) in this embodiment, if the types and the numbers of the coins calculated by the storage state calculating unit 32 (the calculating unit) and the types and the numbers of the coins counted by the dispensing counting unit 34 if the coins are collected are consistent and the designated dispensing content and the types and the numbers of the coins counted by the dispensing counting unit 34 are consistent, the illumination control unit 38 turns on all of the LEDs 20 on condition that the lid 43 covering the storing unit 52 for coins was opened. Therefore, for example, if maintenance work for the coin change machine 10 is performed, it is possible to improve visibility of the inside of the storing unit 52.

The embodiment is explained above. However, the embodiment is an illustration and is not intended to limit the scope of the invention. This new embodiment can be implemented in other various forms. Various omissions, substitutions, and changes can be performed in a range not departing from the gist of the invention. The embodiment and modifications thereof are included in the scope and the gist of the invention and included in the inventions described in the claims and a scope of equivalents of the inventions.

What is claimed is:

1. A money storage device, comprising:
a reception counting component configured to count types of pieces of money and numbers of pieces of money received from an outside of the money storage device;
a calculating component configured to accumulate a counting result of the reception counting component to thereby calculate types of pieces of stored money and numbers of pieces of stored money;
a dispensing counting component configured to count types of pieces of dispensed or collected money and numbers of pieces of dispensed or collected money; and
an illumination controller configured to turn on illumination devices, which illuminate an inside of a storing component, on condition that a lid covering the storing component for money is opened, if the types of pieces of the money and the numbers of pieces of the money calculated by the calculating component and the types of pieces of the money and the numbers of pieces of the money counted by the dispensing counting component if the money is collected are inconsistent or if instructed dispensing content and the types of pieces of the money and the numbers of pieces of the money counted by the dispensing counting component are inconsistent.

2. The money storage device according to claim 1, wherein
the illumination devices are installed for each of types of the money stored in the storing component, and
the illumination controller turns on the illumination device corresponding to a type of money that caused the inconsistency.

3. The money storage device according to claim 1, wherein the illumination controller turns off the illumination devices if the lid is closed.

4. The money storage device according to claim 2, wherein the illumination controller turns on all of the illumination devices, on condition that the lid covering the storing component for money is opened, if the types of pieces of the money and the numbers of pieces of the money calculated by the calculating component and the types of pieces of the money and the numbers of pieces of the money counted by the dispensing counting component if the money is collected are consistent or if the instructed dispensing content and the types of pieces of the money and the numbers of pieces of the money counted by the dispensing counting component are consistent.

5. The money storage device according to claim 1, further comprising a rejection component causes an opening and closing section to open and close based on an output of an identifying component to discharge abnormal coins to a reject tray.

6. The money storage device according to claim 1, further comprising a specifying component configured to specify the type of a coin that causes a jam.

7. A money handling method, comprising:
counting types of pieces of money and numbers of pieces of money received from an outside of a money storage device by a reception counting component;
accumulating a counting result of the reception counting component to thereby calculate types of pieces of stored money and numbers of pieces of stored money;
a dispensing counting component configured to counting types of pieces of dispensed or collected money and numbers of pieces of dispensed or collected money using a dispensing counting component; and
turning on illumination devices, which illuminate an inside of a storing component, on condition that a lid covering the storing component for money is opened, if the types of pieces of the money and the numbers of pieces of the money calculated and the types of pieces of the money and the numbers of pieces of the money counted by the dispensing counting component if the money is collected are inconsistent or if instructed dispensing content and the types of pieces of the money and the numbers of pieces of the money counted by the dispensing counting component are inconsistent.

8. The money handling method according to claim 7, wherein
the illumination devices are installed for each of types of the money stored in the storing component, further comprising:
turning on the illumination device corresponding to a type of money that caused the inconsistency.

9. The money handling method according to claim 7, further comprising:
turning off the illumination devices if the lid is closed.

10. The money handling method according to claim 8, further comprising:
turning on all of the illumination devices, on condition that the lid covering the storing component for money is opened, if the types of pieces of the money and the numbers of pieces of the money calculated and the types of pieces of the money and the numbers of pieces of the money counted by the dispensing counting component if the money is collected are consistent or if the instructed dispensing content and the types of pieces of the money and the numbers of pieces of the money counted by the dispensing counting component are consistent.

11. The money handling method according to claim 7, further comprising:
causing an opening and closing section to open and close based on an output of an identifying component to discharge abnormal coins to a reject tray.

12. The money handling method according to claim 7, further comprising:
specifying the type of a coin that causes a jam.

13. A coin change machine, comprising:
a reception counting component configured to count types of pieces of coins and numbers of pieces of coins received from an outside of the coins storage device;
a calculating component configured to accumulate a counting result of the reception counting component to thereby calculate types of pieces of stored coins and numbers of pieces of stored coins;
a dispensing counting component configured to count types of pieces of dispensed or collected coins and numbers of pieces of dispensed or collected coins; and
an illumination controller configured to turn on illumination devices, which illuminate an inside of a storing component, on condition that a lid covering the storing component for coins is opened, if the types of pieces of the coins and the numbers of pieces of the coins calculated by the calculating component and the types of pieces of the coins and the numbers of pieces of the coins counted by the dispensing counting component if the coins is collected are inconsistent or if instructed dispensing content and the types of pieces of the coins and the numbers of pieces of the coins counted by the dispensing counting component are inconsistent.

14. The money storage device according to claim 13, wherein
the illumination devices are installed for each of types of the coins stored in the storing component, and
the illumination controller turns on the illumination device corresponding to a type of coins that caused the inconsistency.

15. The money storage device according to claim 13, wherein the illumination controller turns off the illumination devices if the lid is closed.

16. The money storage device according to claim 14, wherein the illumination controller turns on all of the illumination devices, on condition that the lid covering the storing component for coins is opened, if the types of pieces of the coins and the numbers of pieces of the coins calculated by the calculating component and the types of pieces of the coins and the numbers of pieces of the coins counted by the dispensing counting component if the coins is collected are consistent or if the instructed dispensing content and the types of pieces of the coins and the numbers of pieces of the coins counted by the dispensing counting component are consistent.

17. The money storage device according to claim 13, further comprising a rejection component causes an opening and closing section to open and close based on an output of an identifying component to discharge abnormal coins to a reject tray.

18. The money storage device according to claim 13, further comprising a specifying component configured to specify the type of a coin that causes a jam.
